(19) United States
(12) Patent Application Publication
(10) Pub. No.: US 2018/0069696 A1
(43) Pub. Date: Mar. 8, 2018

(54) ENCRYPTED DATA MANAGEMENT METHOD AND DEVICE

(71) Applicant: SAMSUNG SDS CO., LTD., Seoul (KR)

(72) Inventors: In Seon YOO, Seoul (KR); Min Hyeok CHOE, Seoul (KR); Yeong Seok PARK, Seoul (KR); Jae Wook CHUNG, Seoul (KR)

(73) Assignee: SAMSUNG SDS CO., LTD., Seoul (KR)

(21) Appl. No.: 15/561,204

(22) PCT Filed: Jun. 8, 2015
(86) PCT No.: PCT/KR2015/005691

§ 371 Date: Sep. 25, 2017

(30) Foreign Application Priority Data
Apr. 14, 2015 (KR) 10-2015-0052399

(51) Int. Cl. H04L 9/08; H04L 29/06; G11B 20/00

(52) U.S. Cl. CPC H04L 9/08; H04L 63/0428; H04W 84/18; H04L 2209/42; G11B 20/00492

(57) ABSTRACT

An encrypted data management method according to one embodiment of the present invention can comprise the steps of: receiving data classified into at least two data types and encrypted for each classified data type by different methods; storing the received data; and performing a search in the stored data.

### TECHNICAL FIELD

The present inventive concept relates to an encrypted data management method and device, and more particularly, to an encrypted data management method and device for managing encrypted data.

### BACKGROUND ART

Recently, information analysis using big data has been actively carried out.

In addition, the technological development and application of the Internet of things (IoT) that enables objects to be connected through the Internet and exchange information with each other have been actively carried out.

If the technological development and application of the IoT is completed, much more big data will be generated and used.

That is, numerous types of information will be collected and analyzed by numerous objects to provide various services and information.

However, information collected by many objects around us, including commonly used smartphones, may include personal privacy information, and the thoughtless collection, storage, and use of such information may cause anxiety about the leakage of personal information and lead to invasion of privacy.

Therefore, data security is important for techniques for managing and using big data.

One way to improve security is to encrypt data and decrypt the data when necessary.

However, it requires a lot of time and money to decrypt encrypted data.

### DISCLOSURE

### Technical Problem

Aspects of the inventive concept provide an encrypted data management method and device which can search and analyze encrypted data without decrypting the encrypted data.

Aspects of the inventive concept also provide an encrypted data management method and device which can perform a search at an increased speed.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

### Technical Solution

According to a first aspect of the inventive concept, there is provided an encrypted data management method including: receiving data classified into two or more data types and encrypted using a different method for each data type; storing the received data; and searching the stored data.

According to an embodiment, the storing of the received data may include storing the received data in a storage space that stores data corresponding to each data type of the received data among storage spaces respectively corresponding to different data types.

According to an embodiment, the searching of the stored data may include: receiving a search word; classifying data types corresponding to the search word; and performing a search in a storage space in which each of the classified data types is stored.

According to an embodiment, the storing of the received data may include storing the received data in an encrypted state without decrypting the received data, and the searching of the stored data may include searching the stored data in the encrypted state using a preset search method.

According to an embodiment, a different search method may be set for each storage space, and the searching of the stored data using the preset search method may include searching the stored data using a different search method for each storage space.

According to an embodiment, the encrypted data management method may further include performing analysis using the stored data.

According to an embodiment, the performing of the analysis may include performing analysis using the stored data in the encrypted state without decrypting the stored data.

According to an embodiment, the performing of the analysis using the stored data in the encrypted state may include: obtaining information from encrypted data to be used for analysis by using a table that stores information matched with the encrypted data; and performing analysis using the obtained information.

According to an embodiment, when the data type of the encrypted data is numerical data, the obtaining of the information may include obtaining information matched with an encrypted value of the encrypted data from the table.

According to an embodiment, when the data type of the encrypted data is format data, the obtaining of the information may include obtaining information matched with an encrypted pattern of the encrypted data from the table.

According to an embodiment, at least one piece of information may be matched with two or more different pieces of encrypted data in the table that stores the information matched with the encrypted data.

According to a second aspect of the inventive concept, there is provided an encrypted data management method including: classifying data received from a plurality of sensors into two or more data types according to a preset method; determining an encryption method for each of the data types; encrypting data corresponding to each of the data types by using the encryption method determined for each of the data types; and transmitting the encrypted data.

According to an embodiment, the classifying of the data into the two or more data types may include classifying one piece of data into two or more data types according to the preset method.

According to an embodiment, the classifying of the data into the two or more data types may include classifying first data as a first data type and second data different from the first data as a second data type according to the preset method, and the encrypting of the data may include encrypting the first data classified as the first data type using a first encryption method and encrypting the second data classified as the second data type using a second encryption method.

According to a third aspect of the inventive concept,there is provided an encrypted data management device including: a data reception unit which receives data classified into two or more data types and encrypted using a different method for each data type; a data storage unit which stores the received data; and a data search unit which searches the stored data.

According to an embodiment, the encrypted data management device may further include a search word reception unit which receives a search word, wherein the data search unit includes two or more sub-search units, each dedicated to a storage space, and a master search unit which classifies data types corresponding to the search word, wherein the master search unit transmits a search command to a sub-search unit dedicated to a storage space in which each of the classified data types is stored.

According to an embodiment, the data search unit nay include two or more sub-search units, each dedicated to a storage space, and a master search unit which transmits a search command to the sub-search units and puts together search results of the sub-search units, wherein each of the sub-search units performs a search using a different search method.

According to a fourth aspect of the inventive concept, there is provided a network intermediate device including a data type classification unit which classifies data received from a plurality of sensors into two or more data types according to a preset method, an encryption method determination unit which determines an encryption method for each of the data types, a data encryption unit which encrypts data corresponding to each of the data types by using the encryption method determined for each of the data types, and a data transmission unit which transmits the encrypted data.

According to a fifth aspect of the inventive concept, there is provided an encryption sensor for each data type, the sensor including a data type classification unit which classifies data corresponding to collected information into two or more data types according to a preset method, an encryption method determination unit which determines an encryption method for each of the data types, a data encryption unit which encrypts data corresponding to each of the data types by using the encryption method determined for each of the data types, and a data transmission unit which transmits the encrypted data.

A computer program according to the fifth aspect of the inventive concept may be coupled to hardware and stored in a medium to execute the encrypted data management method.

### Advantageous Effects

According to the inventive concept, encrypted data can be searched and analyzed without being decrypted. Therefore, the time and money required for decryption can be reduced.

In addition, according to the inventive concept, since there is no data obtained by decrypting encrypted data, information may not be leaked even when data is leaked.

Furthermore, according to the inventive concept, encrypted data can be searched at an increased speed.

However, the effects of the inventive concept are not restricted to the one set forth herein. The above and other effects of the inventive concept will become more apparent to one of daily skill in the art to which the inventive concept pertains by referencing the claims.

### DESCRIPTION OF DRAWINGS

FIG. 1 illustrates the configuration of an encrypted data management system according to an embodiment of the inventive concept;

FIG. 2 is a block diagram of a data management device according to an embodiment of the inventive concept;

FIGS. 3 and 4 illustrate data encrypted according to data type and received by a data reception unit;

FIG. 5 illustrates a data storage unit including a storage space for each data type;

FIG. 6 is a block diagram of an example of a data search unit;

FIG. 7 is an example of a matching information table;

FIG. 8 illustrates an example of the hardware configuration of an encrypted data management device according to an embodiment of the inventive concept;

FIG. 9 is a flowchart illustrating an encrypted data management method according to an embodiment of the inventive concept;

FIG. 10 is an operation flowchart illustrating an encrypted data management method according to an embodiment of the inventive concept; and

FIG. 11 is an operation flowchart illustrating an encrypted data management method according to an embodiment of the inventive concept.

### MODE FOR INVENTION

Hereinafter, exemplary embodiments of the present inventive concept will be described in further detail with reference to the attached drawings. Advantages and features of the inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the inventive concept will only be defined by the appended claims. Like reference numerals refer to like elements throughout the specification.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is for the purpose of describing particular embodiments only and is not intended to be limiting of the invention. As used herein, the singular forms “a”, “an” and “the” are intended to include the plural forms as well, unless the context clearly indicates otherwise.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

The term ‘sensor,’ as used herein, denotes an object that can collect information and transmit the information by using wired or wireless communication. The ‘sensor’ may also be an object included in the Internet of things (IOT).

For example, a sensor of the inventive concept may be a wearable device that is worn on the human body to collect information about the body temperature, heart rate, etc. of the human body.

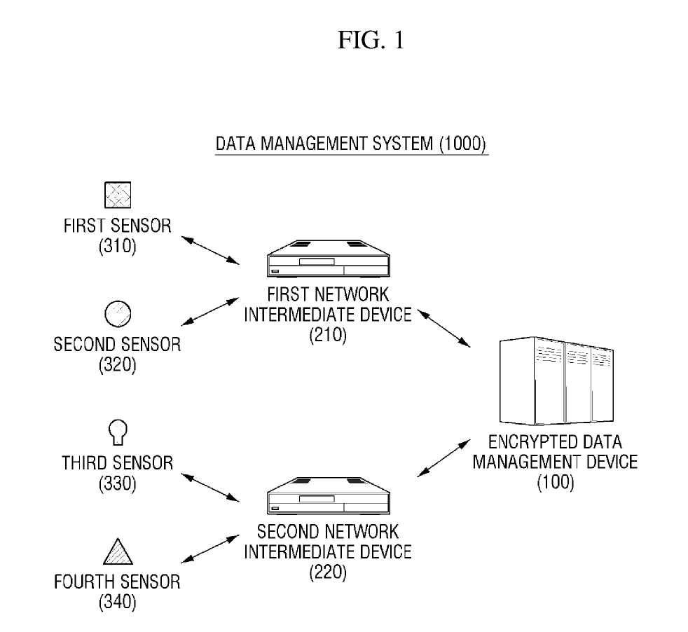

FIG. 1 illustrates the configuration of an encrypted data management system according to an embodiment of the inventive concept.

Referring to FIG. 1, the data management system 1000 according to the embodiment of the inventive concept includes a plurality of sensors 310, 320, 330, 340, etc., one or more network intermediate devices 210, 220, etc., and an encrypted data management device 100.

The sensors include various types of sensors. Each of the sensors 310, 320, 330, 340, etc. may collect and transmit information. Some of the sensors may have a bidirectional communication function, and some of the sensors may have a unidirectional communication function.

Each of the sensors 310, 320, 330, 340, etc. may transmit collected information to the encrypted data management device 100 through the network intermediate device 210, 220, etc. such as a gateway.

The network intermediate devices 210, 220, etc. exist between the sensors 310, 320, 330, 340, etc. and the encrypted data management device 100 to receive data from the sensors and transmit the data to the encrypted data management device 100.

The encrypted data management device 100 receives data on information collected by the sensors 310, 320, 330, 340, etc.

In addition, the encrypted data management device 100 may retrieve necessary information from stored data. Furthermore, the encrypted data management device 100 may perform analysis to obtain information or to obtain information for providing a service.

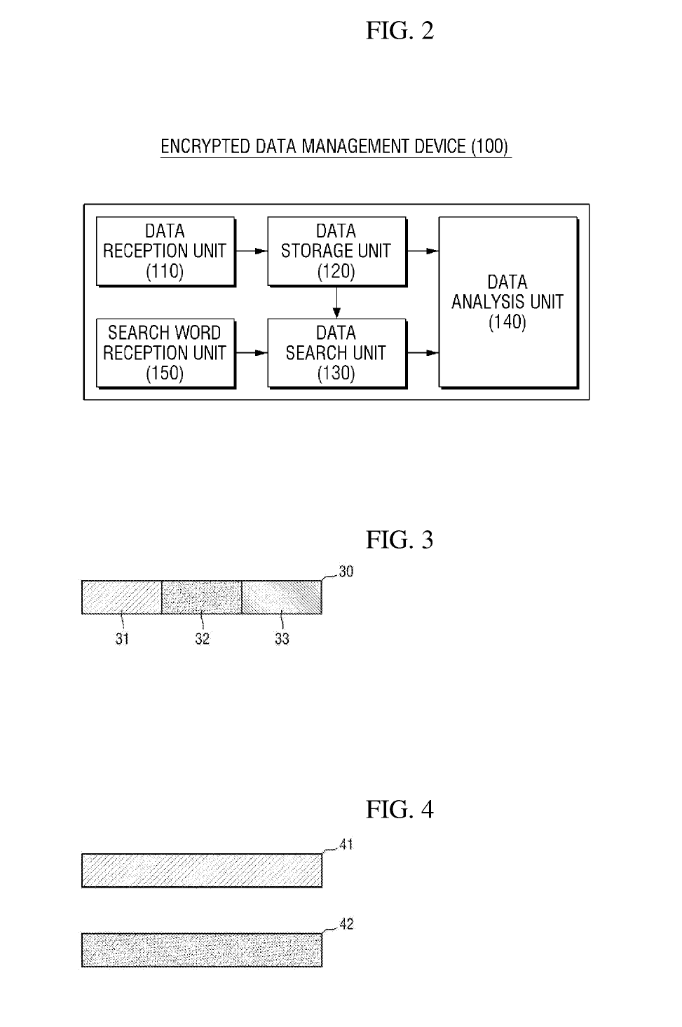

The encrypted data management device 100 will be described in more detail with reference to FIG. 2.

FIG. 2 is a block diagram of an encrypted data management device according to an embodiment of the inventive concept.

Referring to FIG. 2, the encrypted data management device 100 according to the embodiment of the inventive concept includes a data reception unit 110, a data storage unit 120, a search word reception unit 150, a data search unit 130, and a data analysis unit 140.

The data reception unit 110 receives data on information collected by a sensor.

Specifically, the data received by the data reception unit 110 is data classified into two or more data types and encrypted using different methods.

That is, the data reception unit 110 may receive data of a first data type encrypted using a first encryption method and data of a second data type encrypted using a second encryption method.

Alternatively, the data reception unit 110 may receive first data including a data portion corresponding to the first data type encrypted using the first encryption method and a data portion corresponding to the second data type encrypted using the second encryption method.

Data types may be classified according to a preset criterion.

For example, the data types may be classified according to data format, data kind, and/or data transmission method.

For example, the data types may be classified into a numerical data type, a text data type, a format data type, and a stream data type. An encryption method for each data type may be different.

That is, the numerical data type may be encrypted using the first encryption method, and the text data may be encrypted using the second encryption method.

The data type-based encryption method may use existing encryption methods. For example, of the existing encryption methods, an encryption method suitable for encrypting numerical data may be set as an encryption method for data corresponding to the numerical data type.

FIGS. 3 and 4 illustrate data encrypted according to data type and received by the data reception unit.

Referring to FIG. 3, even one piece of data 30 can be classified into two or more data types (31, 32 and 33) based on a preset data type.

A data area 31 classified as the first data type may be encrypted using the first encryption method.

A data area 32 classified as the second data type may be encrypted using the second encryption method.

A data area 33 classified as a third data type may be encrypted using a third encryption method.

Referring to FIG. 4, first data 41 classified as the first data type based on a preset data type is encrypted using the first encryption method.

Second data 42 classified as the second data type based on the preset data type is encrypted using the second encryption method.

Referring again to FIG. 2, the data storage unit 120 may store data received by the data reception unit 110.

The data storage unit 120 may have a storage space for each data type.

That is, the data storage unit 120 may include a plurality of storage spaces. The storage spaces may be spaces into which a single storage space is divided or may be physically separated storage spaces.

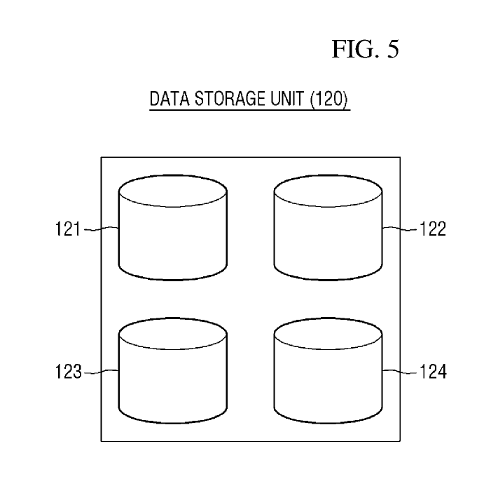

FIG. 5 illustrates a data storage unit including a storage space for each data type.

Referring to FIG. 5, encrypted data corresponding to the first data type may be stored in a first storage space 121. Encrypted data corresponding to the second data type may be stored in a second storage space 122. Encrypted data corresponding to the third data type may be stored in a third storage space 123. Encrypted data corresponding to a fourth data type may be stored in a first storage space 124.

For example, encrypted data corresponding to the numerical data type may be stored in the first storage space 121, and encrypted data corresponding to the text data type may be stored in the second storage space 121.

There may be as many storage spaces as the number of preset data types.

Data stored in the data storage unit 120 is encrypted data.

Referring again to FIG. 2, the search word reception unit 150 may receive a search word.

The search word may be a word input by a user or a word created and input at the user's request. Alternatively, the search word may be a search word generated according to a preset program.

The data search unit 130 may search stored data for data matching the search word.

The data search unit 130 searches data without decrypting the data.

That is, the data search unit 130 may search the data in an encrypted state.

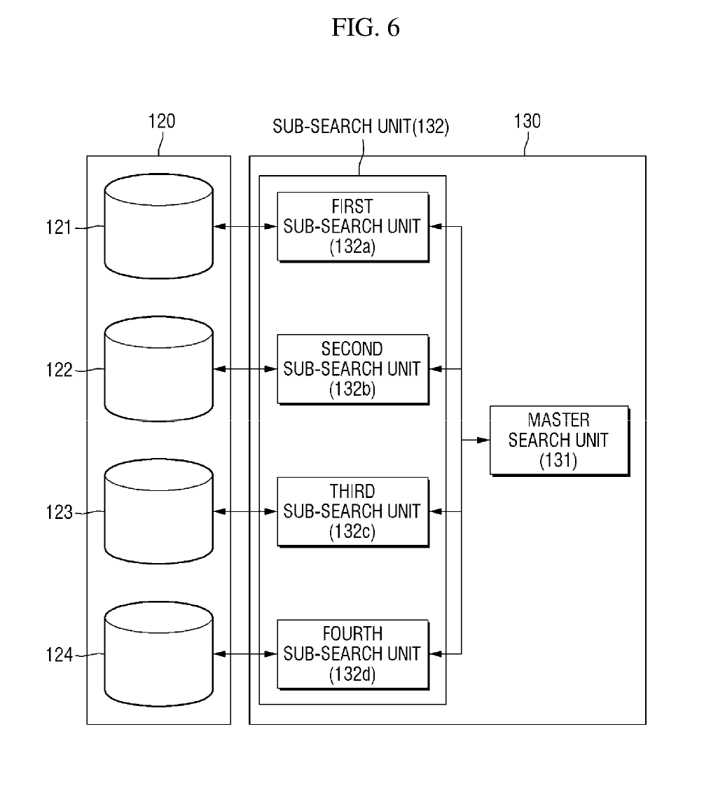

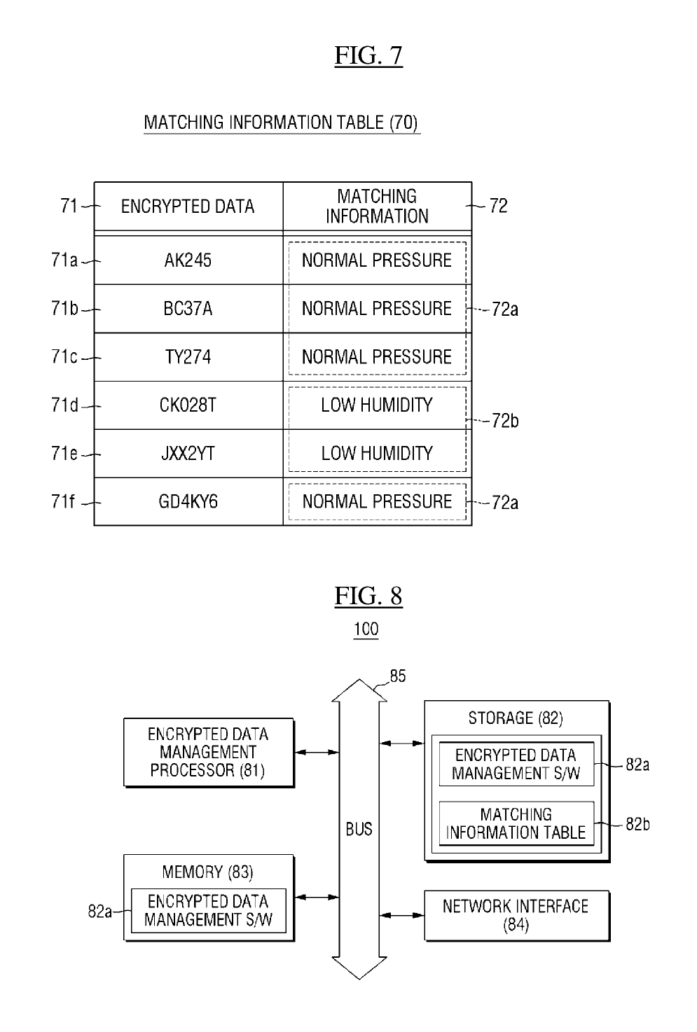

The data search unit will be described with reference to FIG. 6.

FIG. 6 is a block diagram of an example of the data search unit 130.

Referring to FIG. 6, the data search unit 130 may include a plurality of sub-search units 132 and a master search unit 131.

The master search unit 131 may transmit a command to each of the sub-search units 132a, 132b, 132c and 132d to search for data matching a search word. The master search unit 131 may receive and put together search results of the sub-search units 132.

Specifically, when the master search unit 131 transmits one search word to each of the sub-search units 132a, 132b, 132c and 132d, each of the sub-search units 132a, 132b, 132c and 132d may perform a search using an encrypted search word obtained by applying an encryption method for its corresponding data type to the search word. If the search word is a pattern or a range of numbers, the search may be performed using a predefined table (for example, a matching information table) rather than using the search word. Encrypted results output from the sub-search units 132 may be transmitted to the master search unit 131 after being decrypted or without being decrypted. When the master search unit 131 has the function of putting together all encrypted results, the sub-search units 132 may transmit encrypted results.

One sub-search unit 132 may exist for each storage space.

That is, one sub-search unit 132 may be connected to one storage space to perform a search.

A first storage space may be searched exclusively by the first sub-search unit 132a. A second storage space may be searched exclusively by the second sub-search unit 132b. A third storage space may be searched exclusively by the third sub-search unit 132c. A fourth storage space may be searched exclusively by the fourth sub-search unit 132d.

Alternatively, two or more storage spaces may be connected to one sub-search unit 132.

For example, the first storage space and the second storage space may be searched exclusively by the first sub-search unit 132a. The third storage space and the fourth storage space may be searched exclusively by the second sub-search unit 132b.

Each of the sub-search units 132 may perform a search using a different search method.

For example, it is assumed that the first storage space is a storage space for storing encrypted data corresponding to the numerical data type. A method of encrypting data corresponding to the numerical data type is referred to as the first encryption method. In this case, the first sub-search unit 132a dedicated to the first storage space performs a search using a method of searching data, which is encrypted using the first encryption method, in the encrypted state.

In another example, it is assumed that the second storage space is a space for storing encrypted data corresponding to the text data type. A method of encrypting data corresponding to the text data type is referred to as the second encryption method. In this case, the second sub-search unit 132b dedicated to the second storage space performs a search using a method of searching data, which is encrypted using the second encryption method, in the encrypted state. The methods of searching encrypted data can use conventional techniques.

Since each sub-search unit 132 performs a search using a search method suitable for a data type stored in a corresponding storage space, the search can be performed at a higher speed than when a general method of searching encrypted data is used.

In addition, the master search unit 131 may classify data types corresponding to a search word.

The master search unit 131 may transmit a search command to sub-search units 132 dedicated to storage spaces that store the data types corresponding to the search word.

For example, it is assumed that the master search unit 131 classifies data types corresponding to a search word into the first data type which is the numerical data type and the second data type which is the text data type. In this case, the master search unit 131 may transmit a search command to the first sub-search unit 132a dedicated to the first storage space in which data of the first data type is stored and to the second sub-storage unit 132b dedicated to the second storage space in which data of the second data type is stored.

Each sub-search unit 132 may perform a search according to a search command received from the master search unit 131. Each sub-search unit 132 may transmit a search result to the master search unit 131.

The master search unit 131 may receive the search result from each sub-search unit 132 and put together the search results to produce a search result.

Referring again to FIG. 2, the data analysis unit 140 may analyze data using search results or stored data.

The data analysis unit 140 may analyze encrypted data without decrypting the encrypted data.

For example, the data analysis unit 140 may use an encrypted portion for analysis without decryption by using a matching information table which includes the specific encrypted data and information matched with the specific encrypted data.

Specifically, the data analysis unit 140 obtains information matched with encrypted data from the matching information table.

For example, when the data type of the encrypted data is the numerical data type, the data analysis unit 140 may obtain information matched with a encrypted value of the encrypted data from the matching information table.

Alternatively, when the data type of the encrypted data is the format data type, the data analysis unit 140 may obtain information matched with an encrypted pattern of the encrypted data from the matching information table.

For example, different processing methods may be used for a non-structured format and a structured format. Specifically, for example, data in the form of plaintext may use searchable encryption, and the encrypted data may be searched using an encryption key.

The structured format applies a different encryption according to format type, and a pattern of data encrypted according to an encryption may be generated. A search may be performed according to the pattern.

In the case of stream data, when the stream data is transmitted to the data management device 100, not all of the stream data may be encrypted. Instead, only necessary data (for example, key frames) may be encrypted such that they can be extracted. When the encrypted data management device 100 receives the stream data having specific frames encrypted, only the encrypted specific frames may be stored separately from the original stream data. When searching the stream data, the encrypted data management device 100 may use only the specific frames.

The encryption and search processes according to data type will be described using specific examples.

The storage and search processes to be described using examples may be performed by the encrypted data management device 220, and the encryption process may be performed by the sensors 310, 320, 330, 340, etc. or the network intermediate devices 210, 220, etc.

To encrypt and search plaintext, the sensors 310, 320, 330, 340, etc. or the network intermediaries 210, 220, etc. encrypt data of a general text type using searchable encryption. The encrypted data management device 220 stores the encrypted data.

The encrypted data management device 220 may search for data encrypted and stored using searchable encryption by using an encrypted keyword.

Homomorphic encryption can be used to deliver the result of combining encrypted data. For example, if homomorphic encryption is used to deliver the result ‘helloworld’ of combining ‘hello’ and ‘world,’ ‘helloworld’ is encrypted into ‘uryyrjbeyq’ because ‘hello’ becomes ‘hryyr’ and ‘world’ becomes ‘jbeyq.’ Here, ‘uryyrjbeyq’ can be decrypted into ‘helloworld.’

If numerical plaintext is encrypted using homomorphic encryption or Diffie-Hellman encryption, computations such as addition (+) and multiplication (×) can be performed on the numerical plaintext in the encrypted state. As for encrypted data in distributed areas, computations may be performed on the data in the distributed, encrypted state using a multi-party computation method in a cloud to obtain a result.

Data in the structured format may be converted into data in a graph-structured data format to perform feature-based indexing, and confidential data portions may be encrypted to filter or search for a pattern of specific features so that the confidential data portions can be detected only using an encrypted keyword.

Structured data such as web graphs and social networks may be encrypted using a symmetric searchable encryption scheme, and search results may be found only using a specific encrypted keyword. Alternatively, the structured data may be changed to matrix-structured data so as to deliver data encrypted based on a query for labeled data.

In addition, if data can be classified into identity and attribute according to format, functional encryption may be performed. Encryption may be performed according to data type by using property-preserving encryption, order-preserving encryption, or orthogonality-preserving encryption that separates a specific data field and the like according to format and encrypts the specific field.

The data analysis unit 140 may use obtained information for analysis.

An example in which the data analysis unit 140 uses encrypted data without decryption by using the matching information table will be described with reference to FIG. 5.

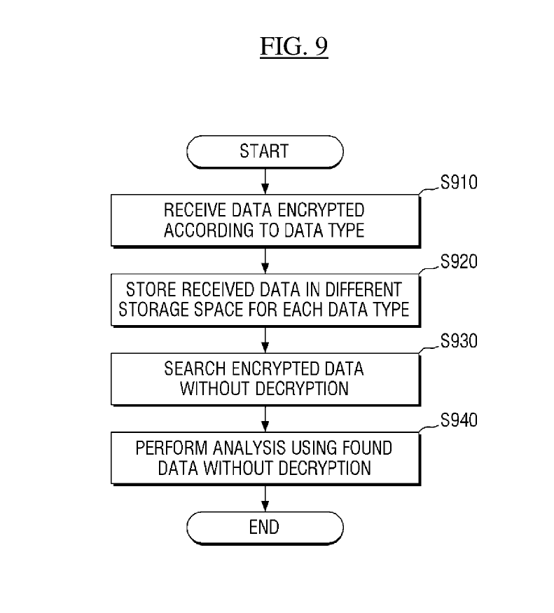

FIG. 7 is an example of the matching information table.

Referring to the matching information table of FIG. 7, when encrypted data is ‘AK245’ 71a, the data analysis unit 140 may obtain data ‘normal pressure’ 72a and use the data for analysis.

When the encrypted data is ‘BC37A’ 71b, ‘TY274’ 71c or ‘GD4KY6’ 71f, the data analysis unit 140 may also obtain the data ‘normal pressure’ 52a.

When the encrypted data is ‘CKD281T’ 71d or ‘JXX2YT’ 71e, the data analysis unit 140 may obtain data ‘low humidity’ 52b.

Referring continuously to FIG. 7, it can be seen that different encrypted data are matched with the same information.

There may be a case where one piece of encrypted data is matched with one piece of information. However, basically, the matching information table may be set such that different pieces of encrypted data are matched with one piece of the same information.

If different pieces of encrypted data are matched with one piece of the same information and the data analysis unit 140 performs analysis by obtaining this matching information, collected information can be protected more securely.

That is, the encrypted data management device 100 according to the embodiment of the inventive concept can analyze encrypted data without decrypting the encrypted data. Therefore, the encrypted data management device 100 does not have a decryption key necessary for decrypting the encrypted data. That is, there is no way to decrypt the encrypted data. Therefore, even if the data is leaked, the exact meaning of the data cannot be identified.

In addition, the matching information table used for analysis does not provide one-to-one matching information. Instead, different pieces of encrypted data are matched with one piece of the same information. Therefore, even if the matching information table is leaked, accurate information about each piece of encrypted data cannot be identified.

FIG. 8 illustrates an example of the hardware configuration of an encrypted data management device according to an embodiment of the inventive concept.

The encrypted data management device 100 according to the current embodiment can be configured as illustrated in FIG. 8.

Referring to FIG. 8, the encrypted data management device 100 may include an encrypted data management processor 81, a storage 82, a memory 83, and a network interface 84.

The encrypted data management device 100 may further include a system bus 85 connected to the encrypted data management processor 81 and the memory 83 and serving as a data movement path.

The network interface 84 may be coupled to another computing device. For example, the computing device connected to the network interface 84 may be a display device, a user terminal, or the like.

The network interface 84 may be Ethernet, FireWire, USB, or the like.

The storage 82 may be, but is not limited to, a nonvolatile memory such as a flash memory, a hard disk, or the like.

The storage 82 stores data of an encrypted data management computer program 82a. The data of the encrypted data management computer program 82a may include a binary executable file and other resource files.

In addition, the storage 82 may store a matching information table 82b.

The memory 83 loads the encrypted data management computer program 82a. The encrypted data management computer program 82a is provided to the encrypted data management processor 81 and executed by the encrypted data management processor 81.

The encrypted data management processor 81 is a processor capable of executing the encrypted data management computer program 82a. However, the encrypted data management processor 81 may not be a processor capable of executing only the encrypted data management computer program 82a. For example, the encrypted data management processor 81 may be able to execute a program other than the encrypted data management computer program 82a.

The encrypted data management computer program 82a may include a series of operations for performing a process of receiving data classified into two or more data types and encrypted using different methods, a process of storing the received data, and a process of searching the stored data.

In addition, the encrypted data management computer program 80a may include a series of operations for performing a process of storing the received data in a storage space corresponding to each data type.

The encrypted data management computer program 82a may also include a series of operations for performing a process of storing the received data without decrypting the received data and a process of searching the stored data using a preset search method that can search the stored data without decrypting the stored data.

Hereinafter, an encrypted data management method according to an embodiment of the inventive concept will be described with reference to FIGS. 9 through 11. The current embodiment can be performed by a computing device having a computing unit. The computing device may be, for example, the encrypted data management device 100 or the encrypted data management system according to an embodiment of the inventive concept. The configuration and operation of the encryption management device or the encrypted data management system can be understood from the above description of FIGS. 1 through 8.

Likewise, the description of FIGS. 1 through 8 can be applied to the encrypted data management method.

FIG. 9 is a flowchart illustrating an encrypted data management method according to an embodiment of the inventive concept.

Referring to FIG. 9, a computing device receives data encrypted according to data type (operation S910).

The data received by the computing device is classified according to data type and stored in each corresponding storage space (operation S920).

A storage space may exist for each data type. The computing device stores the received encrypted data in a storage space without decrypting the received encrypted data.

The computing device searches the encrypted data without decrypting the encrypted data (operation S930).

The computing device may perform analysis using found data in an encrypted state without decrypting the found data in order to obtain necessary information (operation S940).

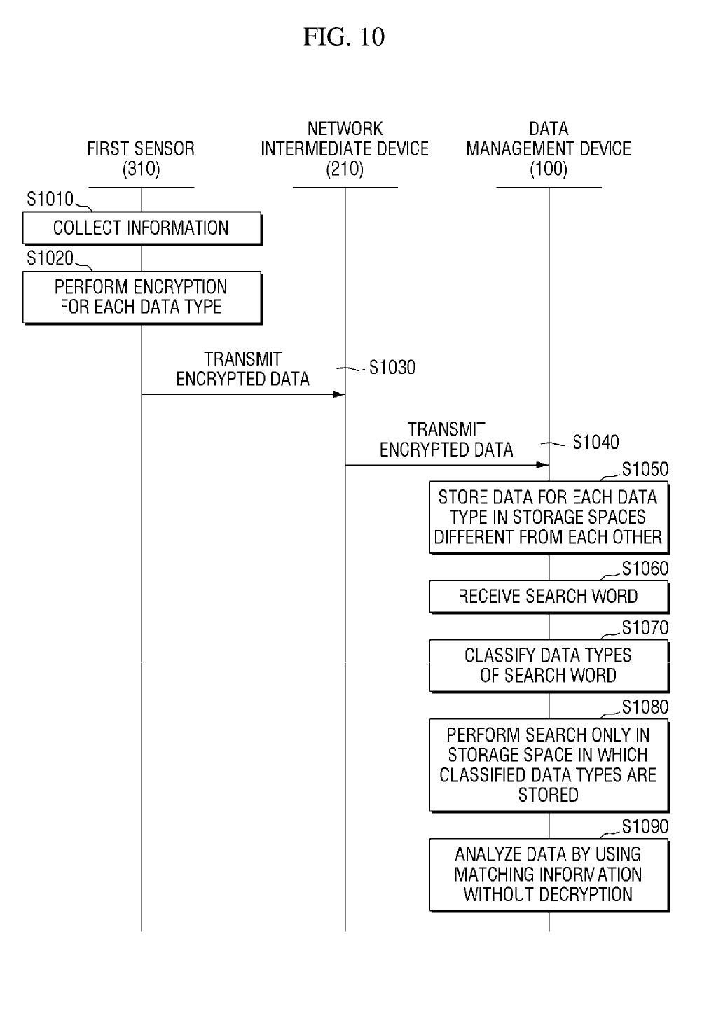

FIG. 10 is an operation flowchart illustrating an encrypted data management method according to an embodiment of the inventive concept.

To help understand the inventive concept, the operation flow between a first sensor 310, a first network intermediate device 210, and an encrypted data management device 100 will be described.

Referring to FIG. 10, the first sensor 310 collects information (operation S1010).

The first sensor 310 classifies data on the information collected by the first sensor 310 into data types according to a preset method. The first sensor 310 determines an encryption method for each data type. The first sensor 310 encrypts data corresponding to each data type by using the encryption method determined for each data type (operation S1020).

The first sensor 310 transmits the encrypted data to the encrypted data management device 100 through the first network intermediate device 210 (operations S1030 and S1040).

The encrypted data management device 100 stores the received encrypted data in a different storage space for each data type (operation S1050).

The encrypted data management device 100 receives a search word (operation S1060). Alternatively, the search word received by the encrypted data management device 100 may be an encrypted search word or may be subjected to an encryption process.

The encrypted data management device 100 may classify data types of the received search word (operation S1070). Alternatively, the encrypted data management device 100 may select a storage space in which a data type to be searched is stored.

The encrypted data management device 100 may perform a search only in a storage space where data corresponding to each of the classified data types of the search word is stored (operation S1080). The search word used for the search may be an encrypted search word. Alternatively, the encrypted data management device 100 may perform a search using the search word only in a selected storage space. The encrypted data management device 100 may search encrypted data files without decrypting the data.

The encrypted data management device 100 may use found encrypted data for analysis without decrypting the found encrypted data (operation S1090). Alternatively, encrypted search results may be decrypted and then used for analysis. The encrypted data management device 100 may obtain information matched with the found data and use the obtained information for analysis.

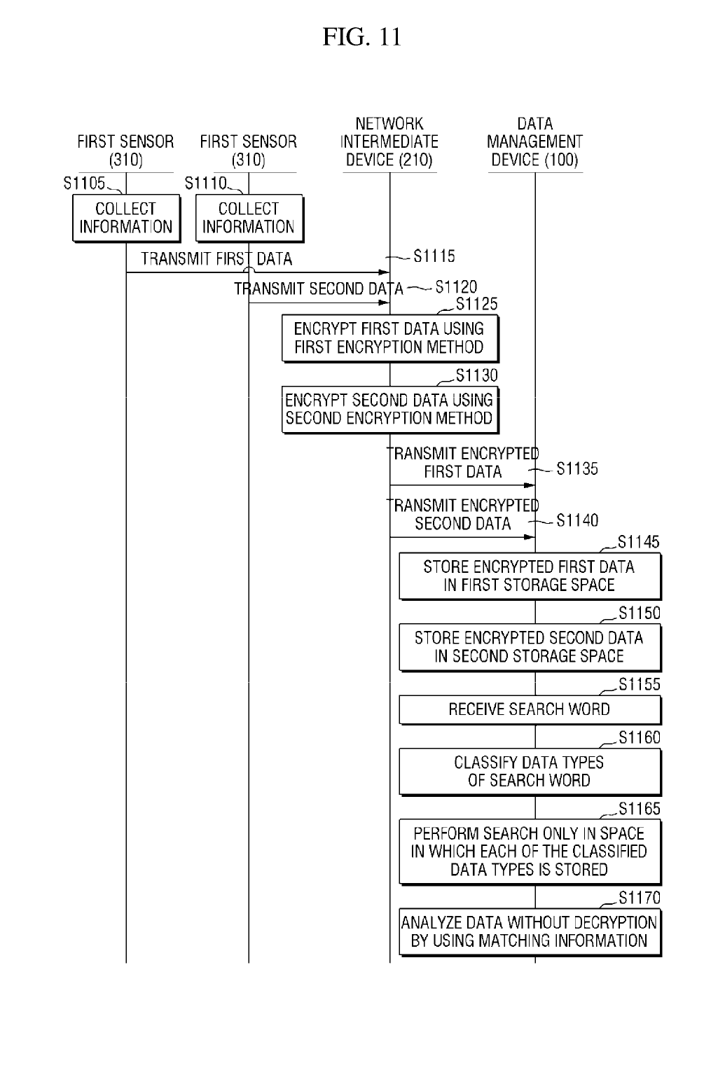

FIG. 11 is an operation flowchart illustrating an encrypted data management method according to an embodiment of the inventive concept.

Referring to FIG. 11, it can be seen that a first network management device encrypts data received from a sensor.

Specifically, a first sensor 310 collects information (operation S1105).

The first sensor 310 transmits first data corresponding to the collected information to a first network intermediate device 210 (operation S1115).

A second sensor 320 collects information (operation S1110).

The second sensor 320 transmits second data corresponding to the collected information to the first network intermediate device 210 (operation S1120)

A first network management device encrypts the first data using a first encryption method corresponding to the data type of the first data (operation S1125).

In addition, the first network management device encrypts the second data using a second encryption method corresponding to the data type of the second data (operation S1130).

The first network management device transmits the encrypted first data and the encrypted second data to an encrypted data management device 100 (operations S1135 and S1140).

The encrypted data management device 100 stores the encrypted first data in a first storage space where data corresponding to the data type of the first data is stored (operation S1145).

The encrypted data management device 100 stores the encrypted second data in a second storage space where data corresponding to the data type of the second data is stored (operation S1150).

The encrypted data management device 100 receives a search word (operation S1155). Alternatively, the search word received by the encrypted data management device 100 may be an encrypted search word or may be subjected to an encryption process.

The encrypted data management device 100 may classify data types of the received search word (operation S1160). Alternatively, the encrypted data management device 100 may select a storage space in which a data type to be searched is stored.

The encrypted data management device 100 may perform a search only in a storage space where data corresponding to each of the classified data types of the search word is stored (operation S1165). The search word used for the search may be an encrypted search word. Alternatively, the encrypted data management device 100 may perform a search using the search word only in a selected storage space. The encrypted data management device 100 may search encrypted data files without decrypting the data.

The encrypted data management device 100 may use found encrypted data for analysis without decrypting the found encrypted data (operation S1170). Alternatively, encrypted search results may be decrypted and then used for analysis.

The methods according to the embodiments described above with reference to FIGS. 9 through 11 can be performed by the execution of a computer program implemented as computer-readable code. The computer program may be transmitted from a first computing device to a second computing device through a network, such as the Internet, to be installed in the second computing device and used in the second computing device. Examples of the first computing device and the second computing device include fixed computing devices such as a server and a desktop PC, mobile computing devices such as a notebook computer, a smartphone and a tablet PC, and wearable computing devices such as a smart watch and smart glasses.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various components in the embodiments described above should not be understood as requiring such separation in all embodiments, and it should be understood that the described program components and systems can generally be integrated together in a single software product or packaged into multiple software products.

Each component described above with reference to FIG. 2 may be implemented as a software component or a hardware component such as a field programmable gate array (FPGA) or application-specific integrated circuit (ASIC). However, the components are not limited to the software or hardware components and may be configured to reside on the addressable storage medium and configured to execute one or more processors. The functionality provided for in the components may be combined into fewer components or further separated into additional components.

While the inventive concept has been particularly shown and described with reference to exemplary embodiments thereof, it will be understood by those of ordinary skill in the art that various changes in form and detail may be made therein without departing from the spirit and scope of the inventive concept as defined by the following claims. The exemplary embodiments should be considered in a descriptive sense only and not for purposes of limitation.

1. A method for managing encrypted data, the method comprising:
receiving data classified into two or more data types, the data being encrypted using a different method for each data type;
storing the received data; and
searching the stored data.

2. The method of claim 1, wherein the storing of the received data comprises storing the received data in a storage space that stores data corresponding to each data type of the received data, the storage space being a storage space from among a plurality of storage spaces respectively corresponding to different data types.

3. The method of claim 2, wherein the searching of the stored data comprises:
receiving a search word;
classifying data types corresponding to the search word; and
performing a search in a storage space in which each of the classified data types is stored.

4. The method of claim 2, wherein the storing of the received data comprises storing the received data in an encrypted state without decrypting the received data, and the searching of the stored data comprises searching the stored data in the encrypted state using a preset search method.

5. The method of claim 4, wherein a different search method is set for each storage space, and the searching of the stored data using the preset search method comprises searching the stored data using a different search method for each storage space.

6. The method of claim 1, further comprising performing analysis using the stored data.

7. The method of claim 6, wherein the performing of the analysis comprises performing analysis using the stored data in an encrypted state without decrypting the stored data.

8. The method of claim 7, wherein the performing of the analysis using the stored data in the encrypted state comprises:
obtaining information from encrypted data to be used for analysis by using a table that stores information matched with the encrypted data; and
performing analysis using the obtained information.

9. The method of claim 8, wherein in response to the data type of the encrypted data being format data, the obtaining of the information comprises obtaining information matched with an encrypted pattern of the encrypted data from the table.

10. The method of claim 8, wherein at least one piece of information is matched with two or more different pieces of encrypted data in the table that stores the information matched with the encrypted data.

11. A method for managing encrypted data, the method comprising:
classifying data received from a plurality of sensors into two or more data types according to a preset method;
determining an encryption method for each of the data types;
encrypting data corresponding to each of the data types by using the encryption method determined for each of the data types; and
transmitting the encrypted data.

12. The method of claim 11, wherein the classifying of the data into the two or more data types comprises classifying a piece of data into two or more data types according to the preset method.

13. The method of claim 11, wherein the classifying of the data into the two or more data types comprises classifying first data as a first data type and classifying second data that is different from the first data as a second data type according to the preset method, and the encrypting of the data comprises encrypting the first data classified as the first data type using a first encryption method and encrypting the second data classified as the second data type using a second encryption method.

14. An encrypted data management device comprising:
a data receiver configured to receive data classified into two or more data types, the data being encrypted using a different method for each data type;
a memory configured to store the received data; and
a data searcher configured to search the stored data.

15. The encrypted data management device of claim 14, wherein the memory is configured to store the received data in a storage space that stores data corresponding to each data type of the received data, the storage space being a storage space from among a plurality of storage spaces respectively corresponding to different data types.

16. The encrypted data management device of claim 15, further comprising a search word receiver configured to receive a search word, wherein the data searcher comprises two or more sub-searchers, each dedicated to a storage space, and a master searcher configured to classify data types corresponding to the search word, wherein the master searcher is further configured to transmit a search command to a sub-searcher dedicated to a storage space in which each of the classified data types is stored.

17. The encrypted data management device of claim 15, wherein the data searcher comprises two or more sub-searchers, each dedicated to a storage space, and a master searcher configured to transmit a search command to the sub-searcher and combine search results of the sub-searchers, wherein each of the sub-searchers performs a search using a different search method.

18. A network intermediate device comprising:
a processor configured to classify data received from a plurality of sensors into two or more data types according to a preset method, determine an encryption method for each of the data types, encrypt data corresponding to each of the data types by using the encryption method determined for each of the data types, and transmit the encrypted data.

19. A method of performing encryption using an encryption sensor, the method comprising:
classifying, using an encryption sensor for each data type, data corresponding to collected information into two or more data types according to a preset method, determining an encryption method for each of the data types, encrypting data corresponding to each of the data types by using the encryption method determined for each of the data types, and transmitting the encrypted data.

20. A non-transitory computer-readable storage medium storing instructions for causing a computer to execute the method of claim 1.
